(19) United States
(12) Patent Application Publication
(10) Pub. No.: US 2011/0074173 A1
(43) Pub. Date: Mar. 31, 2011

(54) STORAGE DEVICE FOR OBJECTS IN A MOTOR VEHICLE

(75) Inventors: Ralf GAUDIG, Ruesselsheim (DE); Klaus KUHLMANN, Nauheim (DE); Werner BERHARD, Nauheim (DE)

(73) Assignee: GM GLOBAL TECHNOLOGY OPERATIONS, INC., Detroit, MI (US)

(21) Appl. No.: 12/890,181

(22) Filed: Sep. 24, 2010

(30) Foreign Application Priority Data
Sep. 30, 2009 (DE) 102009043768.1

(51) Int. Cl. B60R 7/04

(52) U.S. Cl. 296/24.34

(57) ABSTRACT

A storage device is provided for an object in a motor vehicle, that includes, but is not limited to a base and a side wall that defines a receiving space for the object, as well as including, but not limited to at least one elongate, elastic band element, which is mounted in the area of its two ends at least in the side wall. The band element can be transferred from a position abutting against the side wall into a position connecting wall sections, in which it divides the receiving space. In the area of its respective end the band element, a bearing pin at the top and at the bottom is received, the upper bearing pin being mounted in the area of the upper end of the side wall in said side wall and the lower bearing pin being mounted in the base, adjacent to the side wall.

### CROSS-REFERENCE TO RELATED APPLICATION

This application claims priority to German Patent Application No. 102009043768.1, filed Sep. 30, 2009, which is incorporated herein by reference in its entirety.

### TECHNICAL FIELD

The invention relates to a storage device for objects in a motor vehicle, comprising a base and a side wall which defines a receiving space for the objects, as well as comprising at least one elongate, elastic band element, which is mounted in the area of its two ends at least in the side wall, wherein the band element can be transferred from a position abutting against the side wall into a position connecting wall sections of the side wall, in which it divides the receiving space.

### BACKGROUND

A storage device is known from the German Patent Application 10 2008 064 460.9. In this storage device, the receiving space is formed on the one hand by two side wall sections disposed substantially parallel, on the other hand by two side wall sections which are configured to be outwardly curved in relation to the receiving space. One outwardly curved side wall section receives an elongate elastic band element, which in a first stable curved position abuts against this side wall section and can be deformed into a second stable, oppositely curved position. In this deformed position, the horizontally disposed band element divides the receiving space into two partial spaces, the smaller of the two partial spaces being formed between the band element and the wall section, in which this band element is mounted. The partial spaces serve to receive objects, for example, the small partial space serves to receive a drinks container or a drinks can. If the largest possible receiving space is required, it is merely necessary to deform the band element back into the position abutting against this wall region.

A similar configuration of a storage device is known from DE 10 2006 018 859 A1. Two elongate elastic band elements are provided there, each of which can be disposed in two different positions, wherein in each of the positions they can divide a receiving space formed by two side wall sections and a base of the storage device into three partial spaces. In one position of the two band elements arched away from one another, a large middle partial space and two smaller lateral partial spaces are formed for receiving a large container having a substantially circular cross-section. If the two band elements are arched toward one another, the central partial space is reduced and two larger outer partial spaces are obtained for receiving two smaller containers, in particular those having a circular cross-section.

It is known from US 2008/0001423 A1 to provide, in a storage device for objects in a motor vehicle, an elastic flat element, which can be moved from a first snap position into a second snap position. This flat element forms a pocket wall, whereby in one position of the pocket wall a pocket for receiving objects is opened and in the other position it is closed.

It is at least one object to further develop a storage device of the type specified initially such that a particularly advantageous, structurally simply configured, mounting of the band element and a division of the receiving space by means of the band element is possible with a minimum number of components. In addition, other objects, desirable features and characteristics will become apparent from the subsequent summary and detailed description, and the appended claims, taken in conjunction with the accompanying drawings and this background.

### SUMMARY

A storage device is provided in accordance with an embodiment of the invention. In the area of its respective end, the band element receives a bearing pin at the top and at the bottom, the upper bearing pin being mounted in the area of the upper end of the side wall in said side wall and the lower bearing pin being mounted in the base, adjacent to the side wall.

The preceding information “at the top” and “at the bottom” relate to a horizontal arrangement of the base and therefore describe as the upper end, the end of the band element facing away from the base and as the lower end, the end of the band element facing the base. This understanding of the terms also applies to the appropriate information selected hereinafter.

This described mounting of the band element makes it possible to achieve a simple, universal mounting of the band element in the side wall and in the base. In the storage device, this simple mounting enables the provision of a plurality of bearing sites of the bearing pins of the band elements in the side wall and in the base, so that the band element can be positioned at most diverse positions of the storage device. This makes it possible not only to provide a single band element and position this differently, but also to equip the storage device with a plurality of band elements, wherein these plurality of band elements can definitely remain permanently in the receiving space and therefore do not need to be dismounted. It is therefore of advantage to note that the band elements do not get lost because they are stored loose.

If a band element or the band element is not required for dividing the receiving space, it is placed in the position abutting against the side wall. The entire receiving space, undivided, is herewith available for receiving objects. If a division of the receiving space into two partial spaces by means of one band element or into further partial spaces by means of a plurality of band elements is desired, it is merely necessary to transfer the band element from its position abutting against the side wall into the position connecting the wall sections of the side wall. In so doing, the respective band element is in particular disposed in such a manner that it connects opposite wall sections of the side wall.

In particular, a bearing rod is used for mounting the respective end of the band element. This passes through the band element and in the area of the ends projecting from the band element, forms the bearing pins for mounting the bearing element in the side wall and the base.

A particularly simple configuration of the mounting of the bearing rod in the wall element is obtained if the respective end of the band element has a hole passing through said element in the transverse extension to receive a straight region of the bearing rod. Transverse extension of the band element is understood as an extension perpendicular to the base.

It is considered to be particularly advantageous if the base is provided with a plurality of holes for receiving the lower bearing pin in different positions of the band element. Accordingly, the side wall should be provided with a plurality of receptacles for the upper bearing pin in different positions of the band element. Since the respective band element should be oriented perpendicular to the base, preferably the hole in the base and the receptacle in the side wall are disposed in a common vertical plane in relation to the respective end of the band element. In particular, the respective receptacle for the upper bearing pin has a hole and a groove. By this means, not only a plug connection but also a connection of the upper bearing pin in the side wall, secured against rotation, is implemented. As a result, the band element is sufficiently fixed in the area of the respective end in order to absorb forces introduced therein via the objects when dividing the receiving space. These forces occur, for example, when the vehicle is accelerated and as a result, objects tend to move parallel to the base.

The receiving space is, for example, configured to be rectangular. From the point of view of receiving objects having a circular cross-section, however, it is considered to be particularly advantageous if the receiving space has at least one side wall region which is outwardly curved in relation to the receiving space, in particular is semicircularly curved. The other side wall regions are then in particular configured so that they comprise two side wall regions disposed in parallel and one side wall region disposed at right angles to these side wall regions, which connects said side wall regions. The parallel side wall regions of the storage device in particular constitute its long side wall regions.

Usually it will be sufficient to mount the bearing pins exclusively in the area of the longitudinal sides of the storage device. In the event of a suitably long configuration of the band element, this can be transferred into such a position that it abuts against the outwardly curved side wall region and accordingly does not divide the receiving space. On the other hand, it is entirely possible to mount the band element so that in one position it abuts exclusively against the straight side wall region.

In particular, when using a plurality of band elements, as a result of the configuration of the storage device according to the invention, the most diverse non-divided and divided receiving spaces can be formed. Thus, the band element or the band elements can be disposed in a position which does not divide the receiving space. For dividing the receiving space, the band element or the band elements can be positioned in various positions by means of the bearing pins so that a straight, slightly curved, or severely curved position of the respective band element bridging the receiving space is obtained.

In particular, from the last-mentioned viewpoints, it is particularly advantageous if the band element is configured to be multipart, having a plurality of band element sections disposed parallel to one another, which have the bearing rods passing through their ends. The respective band element is thus mounted in the area of its two ends by means of two bearing rods, which pass through continuous holes in the individual band element sections, the band element sections running parallel to the base. The advantage of the configuration of the band element with a plurality of band element sections can be seen in that the band element sections can not only be disposed so that they are curved in the same direction, whereby they have the function of a one-piece band element, but can indeed be disposed so that they are curved in the opposite direction, whereby a partial space can be spanned by means of a band element, which divides the receiving space. From this point of view, it is considered to be particularly advantageous if the band element or the band element sections forming the band element can be deformed from a first stable curved position into a second stable, oppositely curved position.

The elastic band element or the elastic band element sections have, for example, of elastomer, plastic, or flexible steel. The differently oppositely curved stable positions can be achieved as a result of the spring action of the band element or the band element sections.

Band elements are also used in a storage device which can be attached individually on the longitudinal or front side. They can be folded in and folded out, thereby affording the possibility of forming one large receiving space or a plurality of small partial spaces. The arrangement of the band element sections in different planes results in a further possibility for dividing the receiving space. The compartment division can be variably adjusted by folding the band elements or band element sections. As a result of a pretensioning of the band elements, a clamping effect is obtained in variable positions. The band element or the band element sections, for example, have a raised form. Due to the plurality of holes in the base and receptacles in the upper surface of the side wall, which serve to receive the ends of the band elements, it is possible to variably configure the division of the storage device in size and shape by different positioning of the band elements.

The storage device is simply configured, can be operated straightforwardly, and requires only a little space. As a result of the variable dimensioning of the compartments, it is possible to optimally receive different-sized objects.

### BRIEF DESCRIPTION OF THE DRAWINGS

The present invention will hereinafter be described in conjunction with the following drawing figures, wherein like numerals denote like elements, and:

FIG. 1 shows the storage device in a plan view, with band element or band elements disposed in different positions;

FIG. 2 shows in a spatial view a one-piece band element having bearing rods passing through this at the ends in a first position of the arrangement shown;

FIG. 3 shows the arrangement according to FIG. 2 in a second position;

FIG. 4 shows a spatial view of a band element formed from four parallel band element sections with bearing rods passing through the ends of the band element sections;

FIG. 5 to FIG. 7 show arrangements according to FIG. 4 in various positions of the band element sections;

FIG. 6 shows a section through the rod according to the line VI-VI in FIG. 5;

FIG. 8 shows a spatial view of a side wall section with one-piece band element mounted therein, illustrated for the end of the band element facing the side wall section and illustrated for an adjacent region of the side wall section, in which no band element is mounted;

FIG. 9 shows a vertical section through the storage device in the region of the side wall and the base with band section mounted therein, in accordance with the arrangement in FIG. 8; and

FIG. 10 shows a vertical section through the arrangement of side wall section and base shown in FIG. 9 for the region used for fastening the band element.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The storage device 1 for objects is in particular configured as a console in an automobile. The storage device has a base 2 and a peripheral side wall 3 disposed perpendicularly to this. The base 2 and the side wall 3 define the receiving space 4 of the storage device 1, which thus projects as far as the cover surface 5 of the side wall 3.

The side wall 3 is formed by three straight side wall regions 6, 7, and 8 and a side wall region 9 curved outwardly in a semicircular manner with respect to the receiving space 4. The neighboring side wall regions 6, 7, and 8 enclose a right angle with one another and the side wall regions 7 and 8, which form the longitudinal sides of the storage device 1, are disposed parallel to one another. In the area of the side wall regions 7 and 8, the base 2 is provided with a plurality of holes 10 disposed at a distance from one another. Associated with each hole 10 is a receptacle 11 in the area of the cover surface 5 of the side wall region 7 or 8. This receptacle 11 is disposed in the same plane, which runs vertically to the base 2 through the hole 10 and parallel to the alignment of the side wall region 6. In this vertical plane of respective hole 10 and receptacle 11, for example, of the side wall region 9, there also runs a corresponding arrangement of hole 10 and receptacle 11 in the side wall region 8.

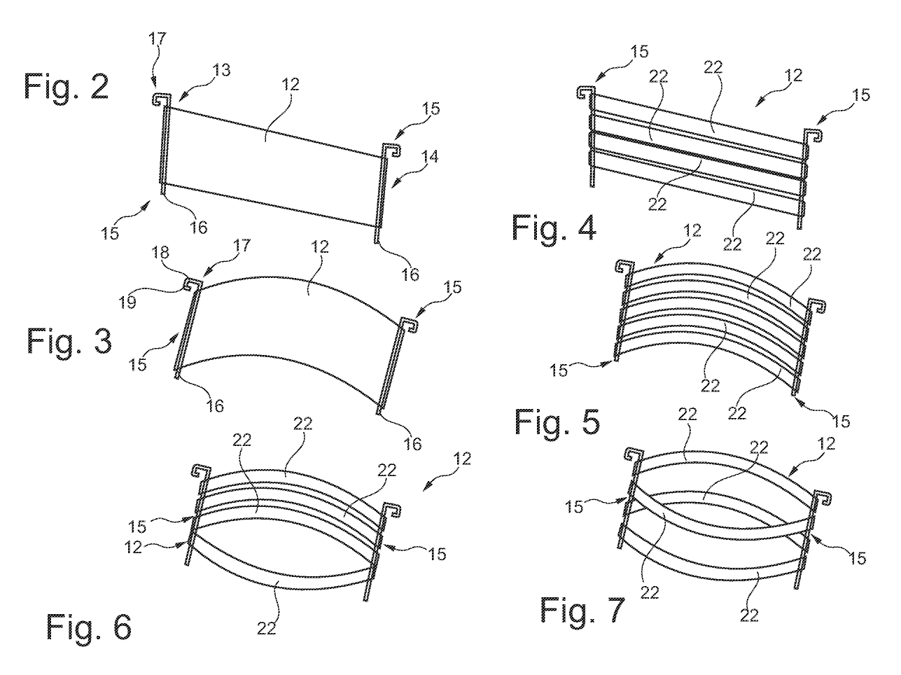

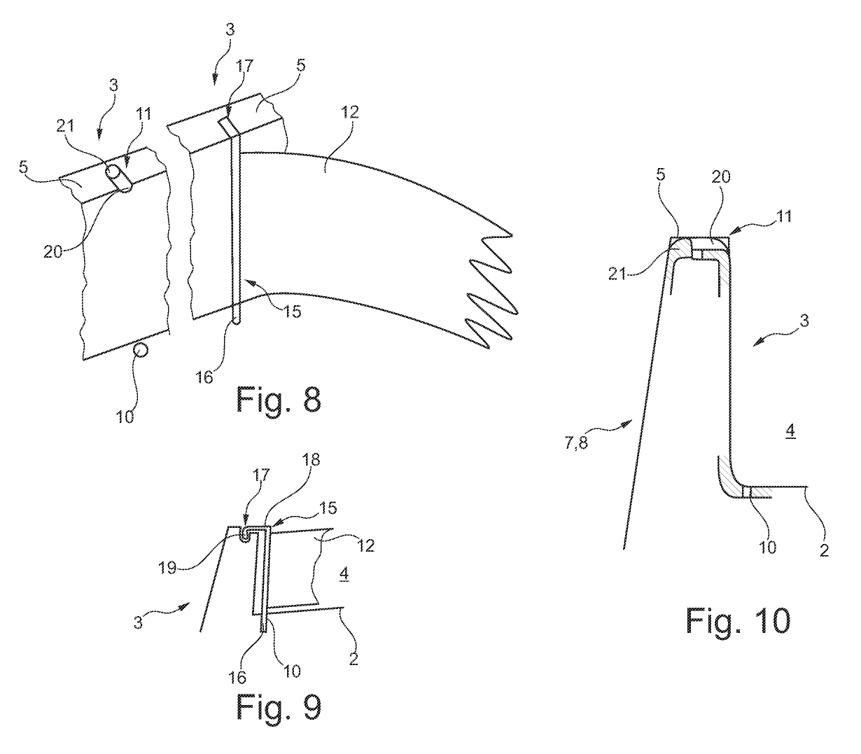

FIG. 2 and FIG. 3 illustrate a one-piece elongate, elastic band element 12, whose length approximately corresponds to the internal circular arc of the side wall region 9 extending over a semicircle and which is therefore longer than the distance of the two parallel-disposed side wall regions 7 and 8. In the area of the respective end 13 or 14, the band element 12 has a hole, not illustrated in detail, which passes through said element in the transverse extension, therefore perpendicular to the base 2, in relation to the mounting arrangement of the band element 12, for receiving a bearing rod 15. This is configured to be straight in the region through which the band element 12 passes and continues further downward in a straight section, which is designated as lower bearing pin 16. When the band element 12 is mounted, the bearing pin 16 engages in the hole 10 associated with this. The bearing pin 15 projects above the band element 12 at the top and above the band element 12, has a U-shaped bearing rod section, which is designated as upper bearing pin 17, having a horizontal region 18 and a downwardly directed free region 19. The respective receptacle 11 in the side wall serves to receive these regions 18 and 19. To this end, the respective receptacle 11 is provided in the area of the cover surface 5 with a groove 20 and a hole 21, the holes 10 and 21 being disposed parallel to one another and the groove 20 being disposed perpendicular to the longitudinal extension of the holes 10 and 21. The respective end of the band element 12 can thus be mounted very simply by inserting a bearing rod 15 through the hole in the area of the end of the band element 12 and inserting the lower bearing pin 16 into the base-side hole 10, and the upper angled bearing pin 17 formed by the regions 18 and 19, into the groove 20 and the hole 21. By this means a secure fastening of the respective end of the band element 12 in the side wall 3 and the base 2 of the storage device 1 is ensured.

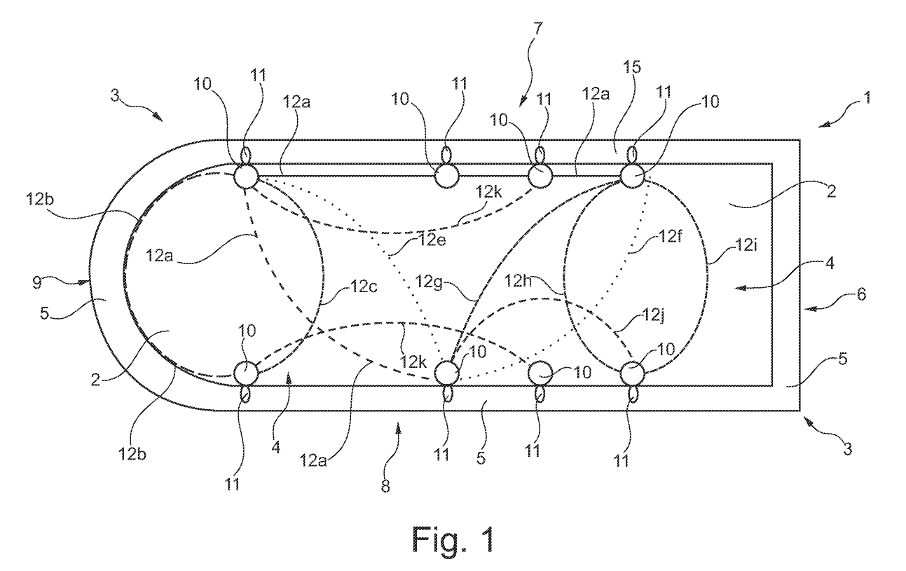

The diverse lines to FIG. 1 shown inside the storage device 1, therefore in the receiving space 4, illustrate various arrangements of a band element or, if more than two divisions of the receiving space 4 are desired, the arrangement of a plurality of band elements, for example, of three band elements. In FIG. 1, in order to make their different positions more easily identifiable, these band elements are not generally designated with the reference number 12 but the different positions of a band element, positioned in different holes 10 and receptacles 11, are characterized by letters added to the reference number 12.

The reference number 12a illustrates the arrangement of the band element, which is parallel to the side wall region 7 and abuts directly against this, whereby the receiving space 4 is not divided. One end of the band element 12 is thus located at the left end of the side wall region 7, in relation to the orientation of FIG. 1, therefore in the transition to the side wall region 9, the other end of this band element 12 in the area of the arrangement of hole 10 and receptacle 11 located furthest to the right in this side wall region 7. The different between the position according to 12a and that according to 12b is that the right-hand mounting of the described straight band element 12 is released and instead, this end is mounted in the transition from the side wall region 8 to the side wall region 9. Consequently, the band element 12b now abuts against the semicircularly curved 9. Against the background that the elongate elastic band element is elastomer, plastic, or flexible steel, and therefore in particular can snap over from one end position into the other end position, in the sense of a flip-flop behavior, the band element 12b can be transferred into position 12c by snapping over said band element without shifting the mounting of the band element. In position 12c this band element, insofar as only one band element is provided, divides the receiving space 4 into two partial spaces. If, for example, the connection of the band element 12 in the transition region of the side wall regions 8 and 9 is released and instead, the connection is repositioned on the side wall region 8 at approximately half the length of the storage device 1, a changed division of the receiving space 4 by means of the band element 12d is obtained. When snapping over from this position, while retaining its bearing axes, a changed position is obtained, illustrated by the band element 12e. If the mounting in the area of the side wall region 8 is retained and that in the transition between the side wall regions 7 and 9 is shifted to the bearing region of the side wall region 8 located furthest to the right, two possible flip-flop positions are obtained, illustrated by the band elements 12f and 12g. These positions can certainly also be implemented by a different band element from that position in accordance with 12c or 12d or 12e.

It is definitely advantageous to provide a different, for example, shorter band element for the right-hand area of the storage device 1 according to the orientation from FIG. 1, the length of said band element nevertheless being substantially greater than the distance of the side wall regions 7 and 8. Thus, the two arrangements of hole 10 and receptacle 11 of the side wall regions 7 and 8 located on the right are connected with a band element 12, whose flip-flop positions are illustrated by the band elements 12h and 12i. If the band element is released at the right end located in the area of the side wall region 7 and instead is connected to the side wall region 8 at half the length of the storage device 1, the position of the band element 12j is obtained.

Furthermore, band elements 12k can each be mounted in the same side wall region 7 or 8, with an arching away from the side wall region in which these are mounted, as is illustrated by the wall elements 12k.

The preceding explanations illustrate that arrangements of the band elements 12 in the immediate vicinity of side wall regions of the storage device 1 are possible, as is illustrated for the position of band element 12a and 12b. Furthermore, mountings of the band elements in a straight side wall region 7 or 8 are possible, with greater or lesser arching for the division of various partial spaces of the receiving space 4, illustrated by the band elements 12j and 12k. Moreover, positions of the band elements are possible, having one end mounted in the side wall region 7 and the other end mounted in the side wall region 8, with stronger curvature in accordance with the band elements 12c, 12h, and 12i and weaker curvature, accordingly rather with diagonal components according to the band elements 12e and 12g.

FIG. 4 to FIG. 7 show an embodiment in which the band element 12 is not formed in one piece but have four band element sections 22 disposed parallel to one another. These band element sections 22 are mounted or fastened in accordance with the band element 12 in the base 2 and the side wall 3 of the storage device 1. FIG. 4 shows the elongate, extended arrangement of the band element sections 22. FIG. 5 illustrates the arrangement of the wall sections 22 arched in the same direction. FIG. 6 shows the three upper wall sections 22 arched in the same direction while the fourth lowest band element section 22 is arched in the opposite direction to the three other band element sections 22. In the embodiment in FIG. 7, the first and third band element sections 22 are arched in one direction and the second and fourth band element sections 22 are arched in the opposite direction.

The storage device 1 is used for receiving most diverse objects, in particular drinks cans or drinks bottles. The receiving space of the storage device can be arbitrarily divided and is therefore most suitable for receiving containers of different sizes and holding them laterally.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A storage device for an object in a motor vehicle, comprising:
a base;
a side wall that defines a receiving space with the base for the object;
an elongate and elastic band element mounted in an area of two ends at least in the side wall,
wherein the elongate and elastic band element is adapted to transfer from a first position abutting against the side wall into a second position that connects wall sections of the side wall and divides the receiving space,
wherein in the area, the elongate and elastic band element is adapted to receive a bearing pin at a top and at a bottom, the bearing pin at the top is mounted in an upper area of an upper end of the side wall in the side wall and the bearing pin at the bottom is mounted in the base, adjacent to the side wall.

2. The storage device according to claim 1, wherein the bearing pin is disposed in the area of an end of the elongate and elastic band element are formed by pin-shaped ends of a bearing rod passing through the elongate and elastic band element.

3. The storage device according to claim 2, wherein the end of the elongate and elastic band element comprises a hole passing through in a transverse extension to receive a straight region of the bearing rod.

4. The storage device according to claim 3, wherein the bearing pin at the bottom is a straight extension of the straight region received by the hole that projects at the bottom beyond the elongate and elastic band element.

5. The storage device according to claim 1, wherein the base comprises a plurality of holes that are adapted to receive the bearing pin at the bottom in different positions of the elongate and elastic band element.

6. The storage device according to claim 3, wherein the bearing pin at the top is adapted to project at the top over the elongate and elastic band element and is a component part of a U-shaped extension of the straight region received by the hole.

7. The storage device according to claim 1, wherein the side wall comprises a plurality of receptacles for the bearing pin at the top in different positions of the elongate and elastic band element.

8. The storage device according to claim 7,
wherein the plurality of receptacles comprises a hole and a groove,
wherein the side wall comprises the hole running perpendicularly to the base on a side facing away from the base and the side wall comprises the groove running parallel to the base and directed from the hole toward the receiving space on the side facing away from the base.

9. The storage device according to claim 1, wherein the receiving space is configured to be substantially rectangular.

10. The storage device according to claim 3,
wherein the receiving space is formed between the base and regions of the side wall,
wherein adjacent side wall regions enclose an approximate right angle with one another and an outwardly curved side wall region in relation to the receiving space connects two parallel-disposed side wall regions and the adjacent side wall regions are arranged at approximate right angles to the base.

11. The storage device according to claim 10, wherein a plurality of parallel side wall regions of the storage device is configured to form long side wall regions.

12. The storage device according to claim 1, wherein the bearing pin is mounted in the area of longitudinal sides.

13. The storage device according to claim 10, wherein in the first position, the elongate and elastic band element abuts against at least one of the outwardly curved side wall region or the straight region of the side wall.

14. The storage device according to claim 1, wherein the elongate and elastic band element is configured to be a multipart comprising a plurality of band element sections disposed substantially parallel to one another and comprising bearing rods passing through at ends.

15. The storage device according to claim 1, wherein the elongate and elastic band element can be deformed from a first stable curved position into a second stable in an oppositely curved position.
